(19) United States
(12) Patent Application Publication
(10) Pub. No.: US 2019/0318582 A1
(43) Pub. Date: Oct. 17, 2019

(54) A LOCATION WAGERING SYSTEM AND METHOD

(71) Applicant: Itay BARAK, Bnei Dror (IL)

(72) Inventor: Itay BARAK, Bnei Dror (IL)

(21) Appl. No.: 16/465,800

(22) PCT Filed: May 10, 2018
(86) PCT No.: PCT/IB2018/053247

§ 371 Date: May 31, 2019

Related U.S. Application Data
(60) Provisional application No. 62/505,045, filed on May 11, 2017.

(51) Int. Cl. G07F 17/32; G06Q 20/32; G06T 19/00

(52) U.S. Cl. CPC G07F 17/3288; G06Q 20/3224; G07F 17/3218; G07F 17/3269; G07F 17/323; G06T 19/006

(57) ABSTRACT

A location wagering system, machine and method are provided, the system including a location wagering server communicatively connected to an end user device via a communications cloud, the wagering server including a display module; an event module; a payment module; and a location wagering processing module, including code for enabling geo-wagering on virtual or actual games.

### FIELD OF THE INVENTION

The present invention relates in general to methods and devices useful in gaming and wagering on events and games.

### BACKGROUND OF THE INVENTION

There are many kinds and types of digitally enabled financial bets, such as betting on sports or mass crowd events such as reality show public votes, elections etc., and gaming events where betting may be for fun or challenge etc.

Typically, the price offers made by users are based on binary results, for example above/below, win/lose, or a price variable, such as above by X points, below by Y points.

In gaming and wagering in general, players are generally motivated by challenges offered by interesting and new wagering opportunities, to entice players to get involved in games and place additional wagers. Accordingly, there is a need for systems and methods that may provide new and interesting sporting event wagers, whether using real money or virtual money, or other challenge related systems.

### SUMMARY OF THE INVENTION

There is provided, in accordance with an embodiment of the present invention, systems and methods of providing a wagering game based on an event or game which provides for location-based wagering opportunities before and during the event.

Some embodiments of the invention are directed to systems and methods for providing a wagering game that involves displaying one or more wagering opportunities that a specific outcome will occur in a game or event, for example, a live sporting game, in the future within a selected location, whether a physical or digital location, during the event; receiving information regarding the selected location outcome of the event; determining if the selected specific outcome occurred in the selected location outcome; and settling the wager by either awarding a payout amount to the participating player if the selected specific outcome occurred in the selected location outcome, or collecting the wager from the participating player if the selected outcome did not occur. The wager may be cash based, virtual points based, or any game denomination units.

A location wagering system is herein provided, for enabling space-based wagering on virtual or actual games, comprising elements described herein.

A method for placing location-based wagers on a live event is herein provided, comprising elements described herein.

A system for pricing bets on future events in sports games or entertainment games is herein provided, comprising elements described herein.

A virtual or physical game space adapted to facilitate location wagering is herein provided, comprising elements described herein.

A 3D game space adapted to facilitate location wagering is herein provided, comprising elements described herein.

An Augmented reality game space adapted to facilitate location wagering is herein provided, comprising elements described herein.

A location wagering system is provided, according to some embodiments, including a location wagering server communicatively connected to an end user device via a communications cloud, the wagering server including a display module; an event module; a payment module; and a location wagering processing module, including code for enabling geo-wagering on virtual or actual games

In some embodiments, the end user device includes a pointing component adapted to place a wager on one or more locations on the end user device display.

In some embodiments, the end user device comprises computing and/or communication devices selected from the group consisting of a PC, TV, tablet, smart phone, wearable device, communications box, game console and media player.

In some embodiments, the end user device is a touch screen device running a Geo-wagering application, adapted for displaying one or location wagering areas, and entering one or more wagers on the one or more location wagering areas using the touch screen of the device.

In some embodiments, the end user device is a screen-based device running a Geo-wagering program.

In some embodiments, the wagering server includes a virtual reality module.

In some embodiments, the wagering server includes an augmented reality module.

A method for placing location wagers on an event is provided, according to some embodiments, including running a location wager application an end user device; imposing a location wager interface over an event being run on the device; receiving a location wager by the device user; processing the location wager to generate one or more wagering opportunities based on the selected location wager; receiving one or more wagers from the user; tracking the event to determine wager occurrence; and delivering the result of the wager in according to the wager placed and the actual event occurrence.

According to some embodiments, the method further includes collecting the wager, if the location wager did not occur.

In some embodiments, the method further comprises paying out the wager gain, if the location wager occurred.

In some embodiments, the event is a live event.

In some embodiments, the method further comprises event is an augmented reality event.

According to some embodiments, a location wagering machine is provided, that includes a wagering module running code to run a location wagering application on multiple end user devices.

In some embodiments, the code is further adapted to run an interface on the one or more end user devices, the interface adapted to receive one or more location wagers based on pre-configured locations or areas, each location area being given a near real-time wager risk-pay calculation.

In some embodiments, the code is further adapted to run an interface on the one or more end user devices, the interface adapted to receive one or more user-determined location area wagers, each location area being given a near real-time wager risk-pay calculation.

In some embodiments, the code is further adapted to run a location wagering application using a virtual reality interface on the one or more end user devices.

In some embodiments, the code is further adapted to run a location wagering application using an augmented reality interface on the one or more end user devices.

A method is provided, according to some embodiments, for placing location-based wagers on an event, comprising: running a location-based wager application on an end user device; imposing a location-based wager interface over an event being run on the device; receiving a location-based wager by the device user; processing the location-based wager to generate one or more wagering opportunities based on the selected location based wager; receiving one or more wagers from the user; tracking the event to determine wager occurrence; and delivering the result of the wager in accordance with the wager location and the actual event occurrence.

In some embodiments the method may include collecting the wager, if the location-based wager did not occur.

In some embodiments the method may include paying out the wager gain, if the geographical wager occurred.

In some embodiments the the event is a live event.

In some embodiments the event is an augmented reality event.

A location based wagering machine is provided, according some embodiments, that includes a wagering module running code to run a location-based wagering application on multiple end user devices.

In some embodiments the wagering module is further adapted to run an interface on the one or more end user devices, the interface adapted to receive one or more location-based wagers based on pre-configured location areas, each location area being given a near real-time wager risk-pay calculation.

In some embodiments the wagering module is further adapted to run an interface on the one or more end user devices, the interface adapted to receive one or more user-determined location area wagers, each location area being given a near real-time wager risk-pay calculation.

In some embodiments the wagering module e is further adapted to run a location-based wagering application using a virtual reality interface on the one or more end user devices.

In some embodiments the code is further adapted to run a location-based wagering application using an augmented reality interface on the one or more end user devices.

In some embodiments the machine further includes an end user device that includes a pointing component adapted to place a wager on one or more location-based spaces on a display of the end user device.

In some embodiments the end user device comprises computing and/or communication devices selected from the group consisting of a PC, TV, tablet, smart phone, wearable device, communications box, game console and media player.

In some embodiments the end user device is a touch screen device adapted for displaying one or more location-based wagering areas, selectable using the touch screen of the device.

In some embodiments the wagering server includes an augmented reality module.

A method for determining a location of an act to be performed in a game is provided, according to some embodiments, the method comprising: receiving a plurality of events associated with performing an act and a plurality of locations associated with performing the act; wherein each of the events is associated with an at least one location from the plurality of locations; analyzing the events; the analyzing is for associating a success rate of the act with each of the locations; and presenting the analysis on a computing device; the presenting comprises a plurality of success rates associated with each of the locations; thereby increasing a success rate of an act occurring during a game.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic representation of a wagering system for allowing a player to place wagers on an event via a user computing device, according to some embodiments of the present invention;

FIG. 2 is schematic view of a gaming server that may be used with the system shown in FIG. 1, according to some embodiments of the present invention;

FIGS. 3A-3C show examples of a series of examples of screenshots including location wagering interfaces, according to some embodiments;

FIG. 4 shows an example of a screenshot including a location wagering interface relating to a rugby or football game, according to some embodiments;

FIGS. 5A-5C show a series of screenshots including a location wagering interface relating to a soccer game being played, the first two figures relating to a virtual game, and the third relating to an actual game, according to some embodiments;

FIG. 6 shows an example of a GUI that includes both a schematic view of a football playing field and a live video view of a game in progress, according to some embodiments;

FIGS. 7A-7B show a series of examples of GUIs that include both 3D animated views of a boxer, and live video views of a boxing event in progress, also showing examples of location wagering areas, according to some embodiments;

FIG. 8A shows an example of a GUI that includes both a schematic view of a basketball field, and a live video view of the game in progress, as well as a location-based wagering interface, according to some embodiments;

FIG. 8B shows an example of a basketball field divided into wagering risk-pay areas or zones, according to some embodiments;

FIGS. 9A-9B show a series of GUIs that includes both a schematic view of a racing track, and a live video view of the event in progress, as well as location wagering interfaces, according to some embodiments;

FIG. 10A is a flowchart showing an example of a process for generating location wagering statistics or probabilities on an event, according to some embodiments;

FIG. 10B is a flowchart depicting a method that may be used with the wagering system, for executing a location wagering process on an event, according to some embodiments; and

FIG. 11 is a flowchart depicting a further method that may be used with the wagering system, for executing a location wagering process on an event, according to some embodiments of the present invention.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

The term “location” refers to selection of an event to occur in a selected space, region, area, position or zone, for example, a space on a field, whether a physical or virtual space. The term “physical location” refers herein to the actual location where an event occurred in a real-life game. The term “digital location” refers herein to the actual location where an event occurred in a digital, virtual or augmented game.

The term “wage box” as used herein refers to a bet or wage that is placed on a zone, space or area, in which the user believes a future event(s) may occur.

The term “game” may refer to substantially any real-world games or events, live or playback games or events, virtual games or events, entertainment, sport or gambling games and events, virtual reality and augmented reality games or events etc.

The term “event” may refer to substantially any event within a game, as well as other situations in which a wagering game may be applied, including substantially any distinctive element, play, action etc. that may be identified in interactive games, challenge video games, virtual reality games, etc., whether a live or a repeat/recorded event. In some embodiments the event is a wagering event.

The term “wager” as used herein may refer to a placement of a bet, a gamble, laying odds, putting real money, virtual money, playing points, a stake, a pledge, taking risk etc., as part of a game, entertainment, competition etc., on a future event or part of event that may happen, whether a real event or a virtual event. Wager may be placed to win real money or virtual money, points, incentives, bonuses prises, awards etc.

The term act refers herein to an activity performed by a participant of a game in a certain event. There is provided, in accordance with an embodiment of the present invention, systems and methods of providing a wagering game based on an event, for example a live sporting event, which provides for location-based wagering opportunities before and during the event, hereinafter referred to as “Location-wagering”.

Some embodiments of the invention are directed to systems and methods for providing a wagering game that involves selecting one or more wagering opportunities that a specific outcome or event will occur in a game, for example a live sports game, in the future within a selected location of a live sporting event; receiving information regarding the selected location outcome of the sports game event; determining if the selected specific outcome occurred in the selected location outcome; and settling the wager by either awarding a payout amount to the participating player if the selected specific outcome occurred in the selected location outcome, or collecting the wager from the participating player if the selected outcome did not occur. In general, a calculation of the probability or likelihood of occurrence of a selected event to happen in a certain place determines the payout percentages, risks, or amount.

In some embodiments, the time periods are uniform periods of time evenly distributed throughout the live sporting event. In further embodiments the time periods for wagers are event based and are non-uniform periods of time, such that a wager placed on an event happening will be valid until that event occurs.

In some embodiments, the specific outcome may include the scoring of one or more points by one or more players or teams involved in the live sporting event. Further, specific outcomes or events that may be wagered on may be varied, according to each game being played. For example, live sporting event wagering may include, for example, wagers on goals, misses, tackles, possession, fouls, or substantially any other game event or occurrence.

Some embodiments of the invention are directed to systems that include one or more communication devices configured, transmitting wager selections and receiving information regarding the selected time period of the live sporting event; and one or more processors configured for: determining if the selected specific outcome occurred in the selected location; and settling the wager received from the participating player by either awarding a payout amount if the selected specific outcome occurred during the selected time period or collecting the wager.

In some embodiments, special purpose pointing devices or event positioning devices may be used, in conjunction with a communication device, to enable Location-wagering placements.

The system may further include one or more display devices, optionally being touch screen devices, “smart” televisions, gesture-based gaming devices and consoles configured for displaying wagering opportunities. The one or more processors, display devices and communication devices may be mounted in a single electronic platform or mounted independently from each other in remote locations. In some embodiments, the communication devices transmit information via a communications cloud or network.

Some embodiments of the invention are also directed to a non-transitory machine readable media for providing a wagering game discussed herein, and in the accompanying materials, and may include one or more software programs, code and/or data segments as necessary to provide any of the methods described herein on one or more machines or to facilitate the installation and operation of such methods in systems described herein.

In one aspect of the present invention a system for providing geo-wagering to a user via a computing device is provided. The system includes a communications network-based event database, the database including: historical data associated with a sport or game type, the historical data generally including data about past events or occurrences associated with teams and/or individual players; location identifiers for these events; data associated with a live or current sport or game type, optionally delivered in real or neo-real time, the current data generally including data about a current event or occurrence associated with teams and/or individual players; and location identifiers for these current events. In some embodiments the historical data associated with location-based identifiers is used to provide statistics that enable provision of geo-wagering options on live or current events.

In some embodiments, one or more wagering opportunities are provided that are indicative of an event outcome occurring in a current game, for example a live sporting event, within a particular location of the current game. In some embodiments, a controller receives a wager request to place a wager from a participating user. The wager being associated with at least one selected event outcome and event in the selected location in which the selected event outcome will occur. The controller responsively generates the wager, receives information regarding the selected location of the live sporting event, determines if the at least one selected event outcome occurred during the selected location, and settles the wager received from the participating player by either awarding a payout amount if the selected event outcome occurred in the selected location or collecting the wager.

In another aspect of the present invention, a method for providing a wagering game to a user. The method includes displaying at least one wagering opportunity on a computing device. The at least one wagering opportunity being indicative of an event outcome occurring in the sporting event in the future in the selected location of the live sporting event. A wager request to place a wager is received from a participating user. The wager being associated with at least one selected event outcome occurring in the selected location in which the selected event outcome will occur. The method includes responsively generating the wager, receiving information regarding in the selected location of the live sporting event, determining if the at least one selected event outcome occurred in the selected location, and settling the wager received from the participating player by either awarding a payout amount if the selected event outcome occurred in the selected location or collecting the wager.

In yet another aspect of the present invention, one or more non-transitory computer-readable storage media, having computer-executable instructions embodied thereon is provided. The computer-executable instructions cause the processor to display at least one wagering opportunity on a computing device. The at least one wagering opportunity being indicative of an event outcome occurring in the live sporting event in the future within in one or more selected locations or regions of the live sporting event. The processor receives a wager request to place a wager from a participating user, wherein the wager may be associated with at least one selected event outcome in a location or defined space, in which the selected event outcome will occur. The processor responsively generates the wager, receives information regarding the selected location of the live sporting event, determines if the at least one selected event outcome occurred during the selected location, and settles the wager received from the participating player by either awarding a payout amount if the selected event outcome occurred in the selected location or collecting the wager.

According to some embodiments, a system, platform and method are provided to enable remote user investment placing, hereinafter referred to as wagering, where users can place wagers visually on a screen, on a graphical space in which a future event may occur. In some embodiments, the screen being used to view an event may be aided by a constant data feed and the ability to know how much gain the user can potentially win as long as the event plays out within the selected area of a location wager selected. Further, in some embodiments, event types may be selected for a wager, for example, in a live sports game, the location wager may be based on a parameter or parameters one chooses, such as the area of the field where the ball or a player will be at time x.

In further embodiments, the system and platform may enable users such as traders to place complicated trading algorithms by choosing relevant areas on trading graphs and/or charts, such that the visual or location selections may be translated to the appropriate trading commands which may be input into the trading terminal (i.e. Bloomberg terminal).

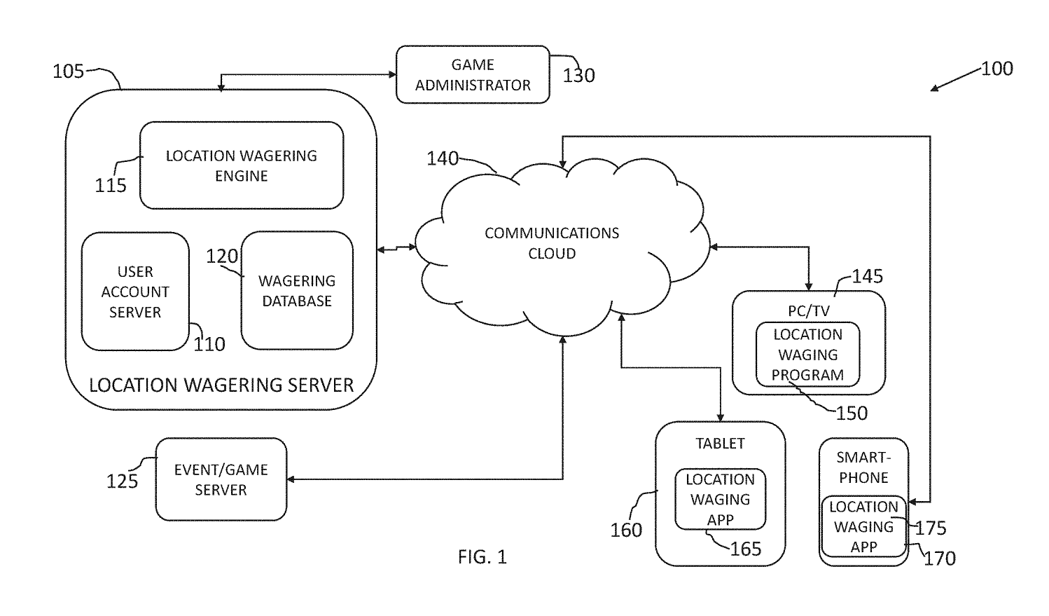

Reference is now made to FIG. 1, which is a schematic system diagram depicting a location wagering system (LWS) 100 for facilitating the placing of location wagers on an event, according to some embodiments. As can be seen, GWS 100 includes a location wagering server 105 that is coupled to a communications cloud 140, to support location wagering programs or applications 150, 160, 170 on a plurality of end user devices such as 145, 160, 170. Generally, wagering programs or applications 150, 160, 170 may be displayed or implemented in an appropriate graphical interface (GUI) on the end user device. Communications server 140 may include the Internet, cellular telecommunications networks, satellite communications networks, wireless networks, cable networks, and/or any suitable telecommunication network that enables the user computing devices to be served by wagering server 105. In some embodiments, end user devices 145, 160, 170 may include a mobile computing device, smartphone, tablet, wearable device, personal computer, laptop, cell phone, personal/home video game device, smart TV, and/or any suitable computing device that enables a user to connect to the wagering server 105 and display and interact with a location wagering engine (LWE) 115.

In some embodiments, multiple users may simultaneously place wagers on an event being followed or played, for example a live event, such as a live sporting event. Each end user device 145, 160, 170 is adapted to run a location wagering program, code or application (LWA), and is further configured to transmit and receive data to and/or from the communications cloud 140, to further be responsive to location wagering server 105. LWA 150, 160, 170 is adapted to provide graphical interfaces to enable a user to follow and/or play a plurality of events or games, rendered by event/game server 125, and to generate one or more wagers on a plurality of event outcomes associated with one more selected events, for example live sporting events, via user device 145, 160, 170.

In some embodiments, wagering server 105 includes a location wagering engine or controller (LWE) 115, communicatively coupled to a user account server 110 and a wagering database 120, to provide game tracking, monitoring, statistical analyses, wagering calculations, betting management, account updating etc., for one or more games being played or viewed by system users. User account server 110, in some embodiments, may be used to keep an updated accounting of each user's bank account, transaction history, payout history etc. Wagering server 105, in some embodiments, may be used to keep updated record of events, users, user profiles, user behavior history, etc.

Wagering server 105 may further include information associated with one or more events, for example live sporting events, to facilitate allowing multiple users to place one or more wagers on a plurality event outcomes of selected event. The information may include, for example, one or more location related event outcomes associated with an event, teams and/or players participating in the sporting event, points, goals, penalties, fouls, runs, and/or any suitable information associated with an event, for example for a live sporting event. In some embodiments, geo wagering engine 115 receives information associated with one or more events or games, and generates and stores the event information in the wagering database 120. In some embodiment, the game or event server 125 may receive event information from a live event broadcast server via communications network 140. In such cases, the live event broadcast server may be configured to broadcast information indicative of live events, to allow an end user to view a live game, or a version of the live game, on their end user device(s).

In some embodiments, location wagering server 105 may be in communication with a game administrator 130, who or which may be responsible for managing one or more games or events served by location wagering server 105.

Furthermore, location wagering server 105 may include a game or event server 125, optionally being a live game or event server, to deliver or render events or games to wagering server 105. In some embodiments event server 125 may function as a live event server, optionally to deliver live streaming of events in place of or in addition to the rendition of a schematic or animated type of game or event view.

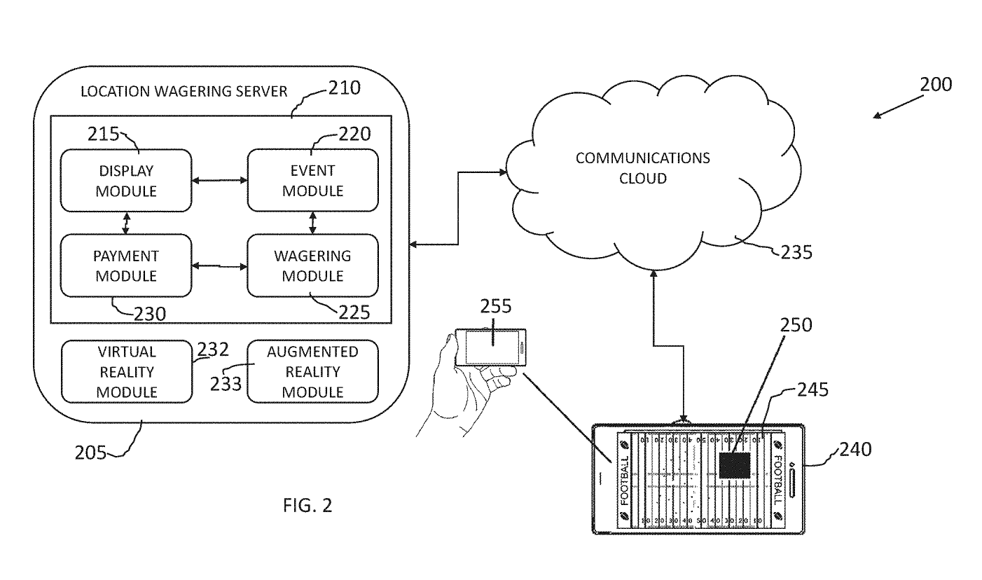

FIG. 2 is schematic view of a gaming server 205, that may be used with the system shown in FIG. 1, optimized to enable location wagering on an end user device 240, in accordance with some embodiments. In some embodiments gaming sever 205 may incorporate historical data, game related data, a vector velocity calculation engine, probability calculation engine, spread management, and book management modules, to facilitate quote management.

In some embodiments gaming sever 205 may calculate the probability or likelihood using an algorithm(s) that includes weighing the general probability of an occurrence of a selected event in a selected location space, for example, based on one or more of: the type of game or event, the current game position and/or situation, the level of challenge, the playing of historical games, the players involved, the location, time, season etc. of play, and/or other relevant game outcome related parameters.

As can be seen, gaming server 205 may also include a Location wagering engine (LWE) 210, that generally includes: a display module for enabling display of a game on an end device, optionally a live game or event, adapted to be viewed on multiple end user devices using a GUI 255 adapted to facilitate user location generated wagers (LGW) 250 placed on a rendition of a playing area or field 245, optionally using touch screen command entry. In some embodiments LGW 250 may include dynamically generated payouts, quotes or figures statistically relating to the shape, position and size of the LGW(s). LWE 210 may further include an event module 220, for producing or delivering a frame being played or scene being viewed to multiple end user devices. LWE 210 may further include a wagering module 225, for processing, generating, managing wager statistics, opportunities, calculations, etc. In some embodiments, wagering module 225 runs code, optionally including Artificial Intelligence (AI) to substantially in real time record new statistics of team/player performance, and process the latest data and the historical data to generate updated wager statistics, opportunities, calculations etc. LWE 210 may further include a payment module 230, for managing records and the status of a user's wagers, for past wagers, current wagers, and payment account details and status etc.

In some embodiments, gaming server 205 may include a virtual reality (VR) module 232, to support virtual reality functionality when viewing, tracking, placing and managing wagers on an event.

In some embodiments, gaming server 205 may include an augmented reality (AR) module 233, to support augmented reality functionality when viewing, tracking, placing and managing wagers on an event.

In some embodiments, gaming server 205 may be a special purpose machine for managing location wagering on multiple end user devices, where wagers are generated, displayed and executed based on a location positioning element.

I still further embodiments a special purpose location wager system is provided, that includes a location gaming server that interacts with an end user pointing and placement device or mechanism, for example, touch screen, mouse, pointing mechanism, gesture recognition mechanisms etc., for enabling an end user to enter a location based wager on a game or event in progress being played or viewed on an end user device.

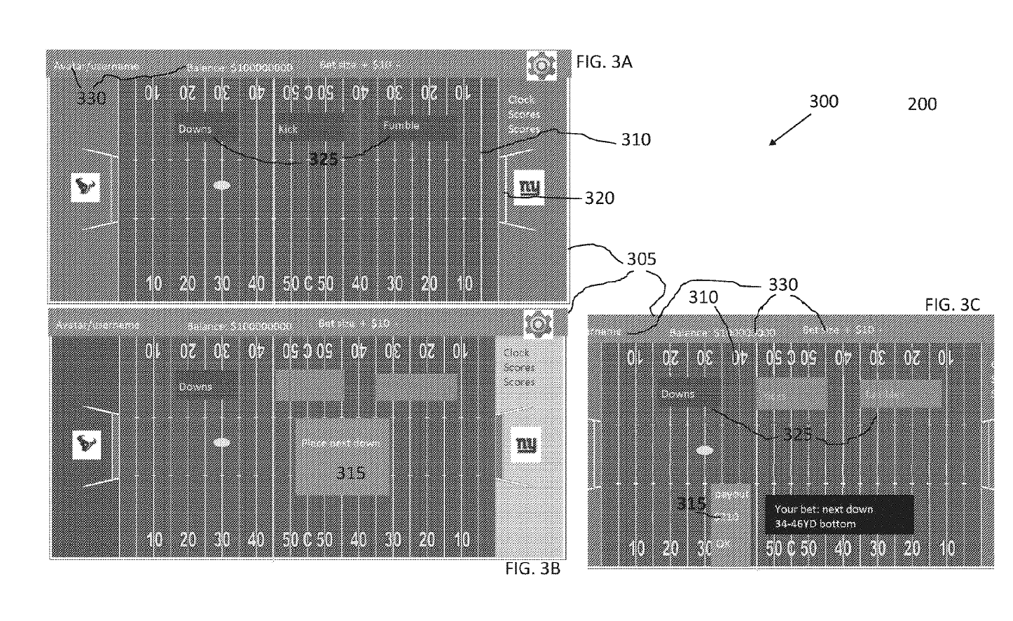

Reference is now made to FIGS. 3A-3C, which show a series of examples of screenshots 300, according to some embodiments, incorporating a graphical user interface (GUI) 305 displaying a view of a game being viewed or played on a game field 310 or space, where the game includes one or more location wagering windows (LWW) 315. As can be seen in these figures: a rendition of a field of a game being viewed or played is shown, and where various playing zones or areas are shown, as are the goals 320, several blocks showing game information or statistics 325 of the game in play, such as number of downs, kicks, fumbles etc., and several blocks showing user related information fields 330, such as username, account balance, and bet size etc.

In some embodiments, LWW 315 are flexible, draggable, moveable, expandable and contractible windows, which allow users to determine the position, size, shape and other characteristics of their location wagers. Further, LWW 315 may display within or outside the windows betting numbers, probabilities, payout values, risk values etc. associate with a selected window shape, size, position etc. As can be seen, one or more LWW 315 may be applied to a game.

In further embodiments, screenshot GUI 305 may display an image of a playing field 310 that is indicative of a corresponding live event, such as a sporting event. For example, the GUI may display a wagering event associated with a live football game, including displaying corresponding event information on or around the football field, and with one or more LWW or location betting zones. The event information may include, but is not limited to, an audio or video feed image of the event, a current score, game information or statistics, and/or any suitable event information associated with the live sporting event. Further, the one or more LWW may provide an indication of an outcome of the live sporting event, and the related wagers or payouts to be won by the user if the selected future event(s) occur in the selected zone(s). Further, if the user wins a wager, the system will settle the respective wagers received from the participating player(s) by either paying in accordance with the payout value, or receiving the money wagered by the user.

The wage box may typically be moveable and flexible to allow positioning and shaping as wanted by the user, and generally displays a bet string, risk/reward for an event type selected, for a selected time and within a selected space. In these ways, a user may act as their own bookie, by determining what bet or bets may be placed on a game, with the risks, gains, frequencies etc. they choose, and whereby any selected bet may display its bet string or some relevant waging rewards, gains, risks, and statistics in general.

In some embodiments a plurality of wager boxes may be placed on a field, representing different wages being placed on a game.

In some embodiments wager boxes may be dragged, expanded, reduced or otherwise adjusted in size, shape and/or position, by a user, representing different wages being placed on a game.

In some embodiments wager boxes may be dragged, expanded, reduced or otherwise adjusted in size, shape and/or position, by a user, representing different wages being placed on a game.

In some embodiments wager boxes may be generated by a user using virtual reality tools or elements.

In some embodiments wager boxes may be generated by a user using augmented reality tools or elements.

In some embodiments dynamic odds and rewards are provided to users, being customized according to user preferences throughout a game, depending on the current game situation. In some cases, data or information such as betting, payout, account information etc., can be displayed inside the wager boxes, whereas in other cases data or information such as betting, payout, account information etc., can be displayed outside the wager boxes.

In some embodiments wagering calculations are generated based on a Self-learning neural network, that learns patterns from past and present games to enable increasingly accurate probability assessments.

In further embodiments, the LWW or betting module may be in communication with the system's payment module 230, for example, to receive user payments, pay out user earnings, manage user credits, determine account status, apply benefits or bonuses, etc.

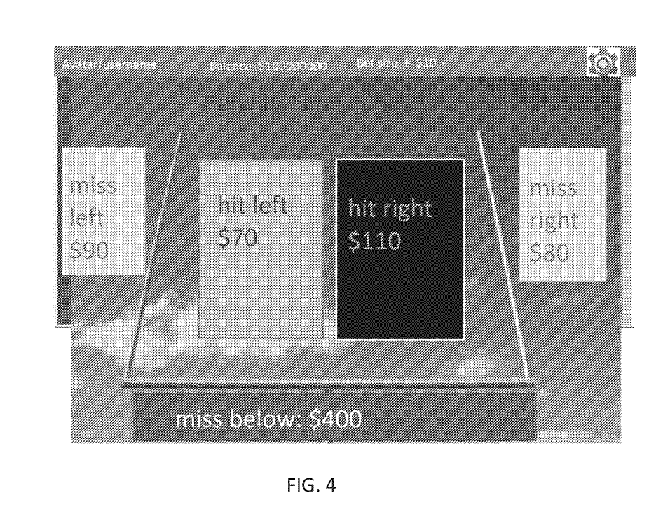

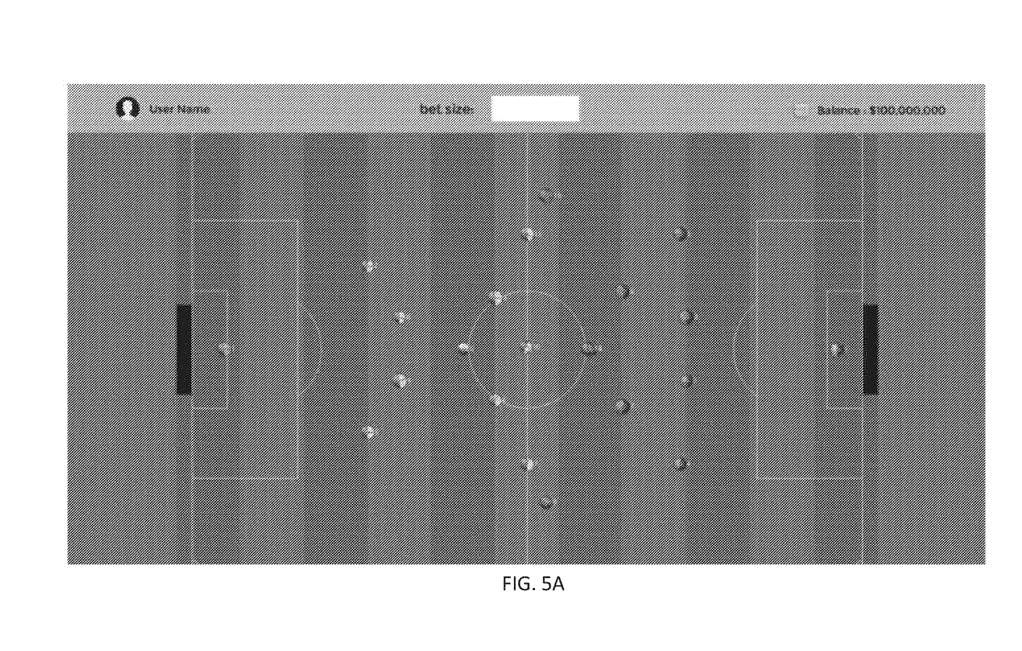

FIG. 4 shows an example of a screenshot including a location wagering interface relating to a rugby or football game, according to some embodiments, that can be displayed on a plurality of end user devices, to facilitate location wagering. As can be seen in the figure, a rugby type goalpost is shown, along with several location wagering spaces, to allow a game viewer to wager on whether a goal will be kicked, and where, and if not where the miss will be located. The respective wagering spaces also show dollar amounts of payouts to be earned if the future event occurs in the respective selected spaces, in accordance with the probabilities of such occurrences.

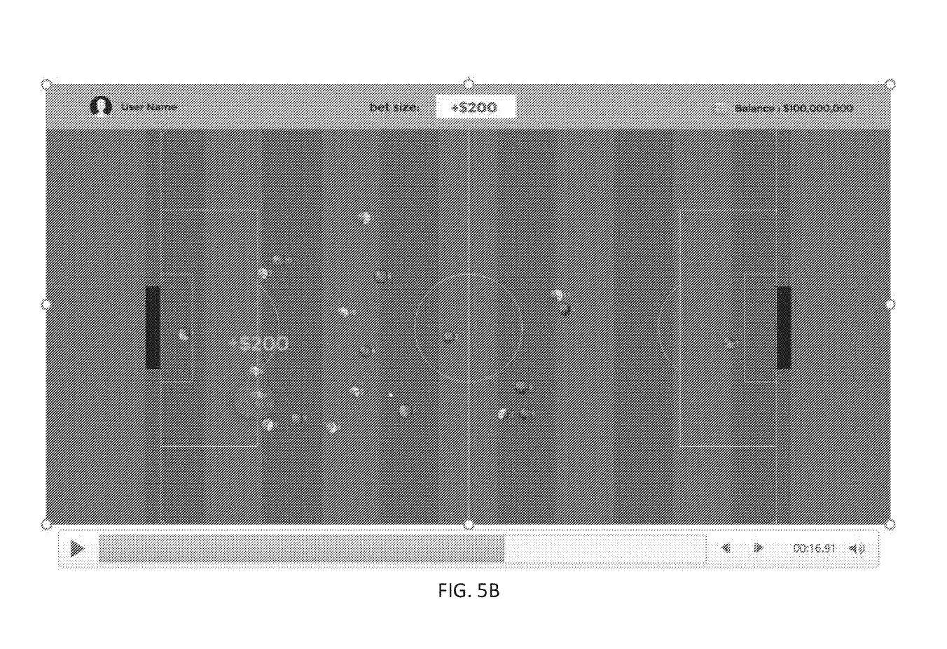

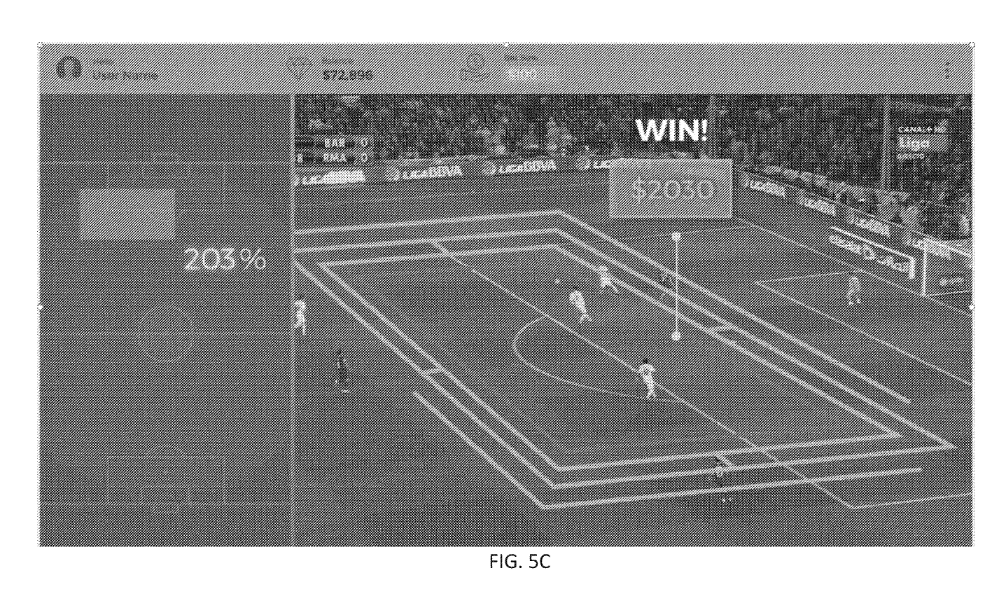

As can be seen in FIGS. 5A-5C, examples are provided of screenshots including a location wagering interface relating to standard soccer game being played, according to some embodiments. In FIGS. 5A and 5B, a virtual game with symbolic players is shown in 2 stages. In FIG. 5C, an actual game is shown, wherein the GUI provides both a schematic view of the field, where a wagering area may be selected, for example, the furthest distance the team offence will reach, and a real video feed panel, where the selected waging space is superimposed over the actual game space (field) and the calculated upside is presented. Generally, the user may select a bet size to place on the game, and subsequently to select one or more event types, and select for each event chosen, a location area where the bet will be placed on the likeliness of the event to occur in that chosen space. The bet payout, risk rate etc. will be calculated and presented to the user, in accordance with the bet or wager calculations made by the systems wagering engine.

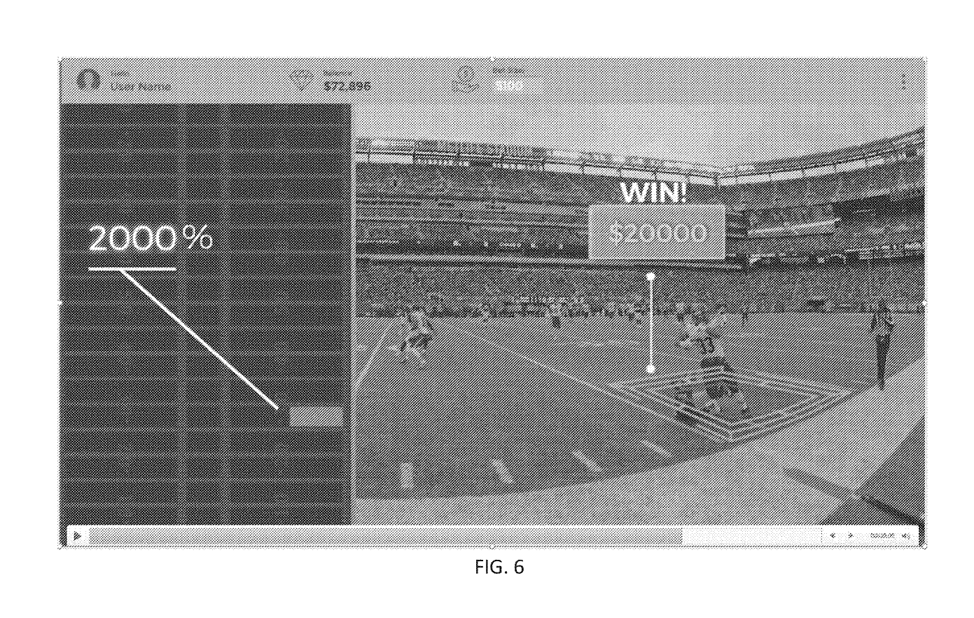

As can be seen in FIG. 6, an example of a GUI is shown that include both a schematic view of a football playing field and a live video view of a game in progress. In the example provided, an example of a future event may be where the next tackle may occur on the runner, as can be seen, with its calculated payout value. Of course, various other examples of bet types may be used.

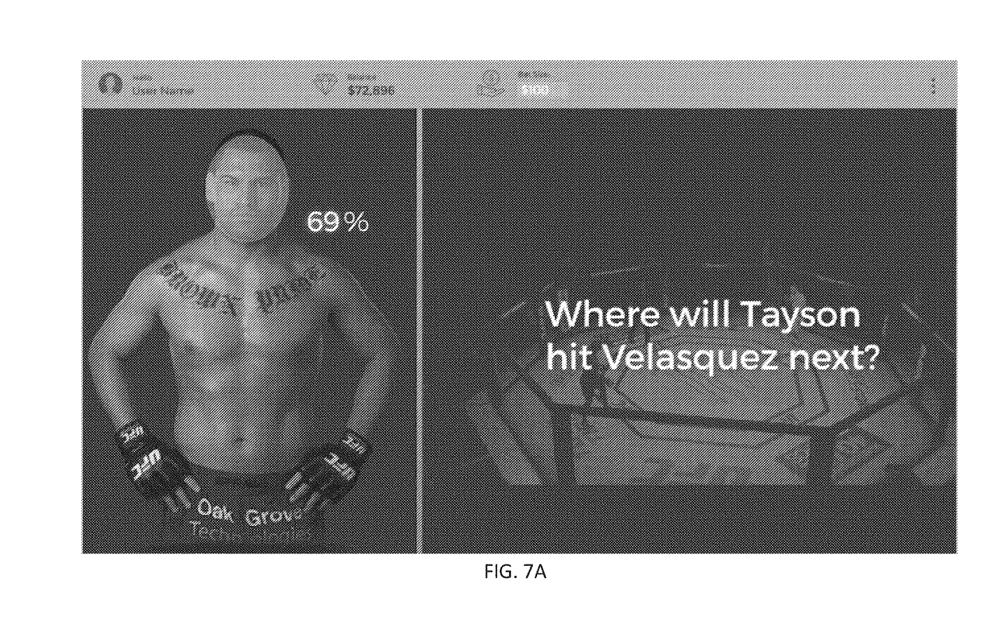

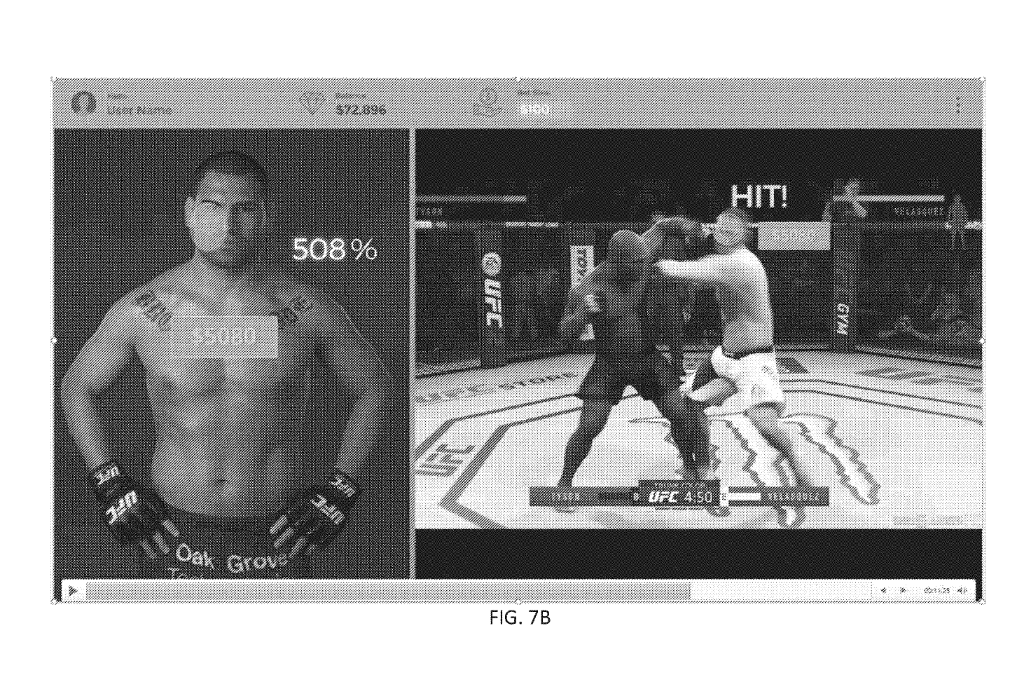

As can be seen in FIGS. 7A-7B, a series of GUIs are shown that includes a live video view of the game in progress, and also show examples of location wagering areas, according to some embodiments. In the examples provided, an example of a future event may be where the next landed box may occur on the one boxer, or various other examples. As is clearly shown by the percentage upside and payout values shown, the wagering box size and position impact on the calculated risk or bet values.

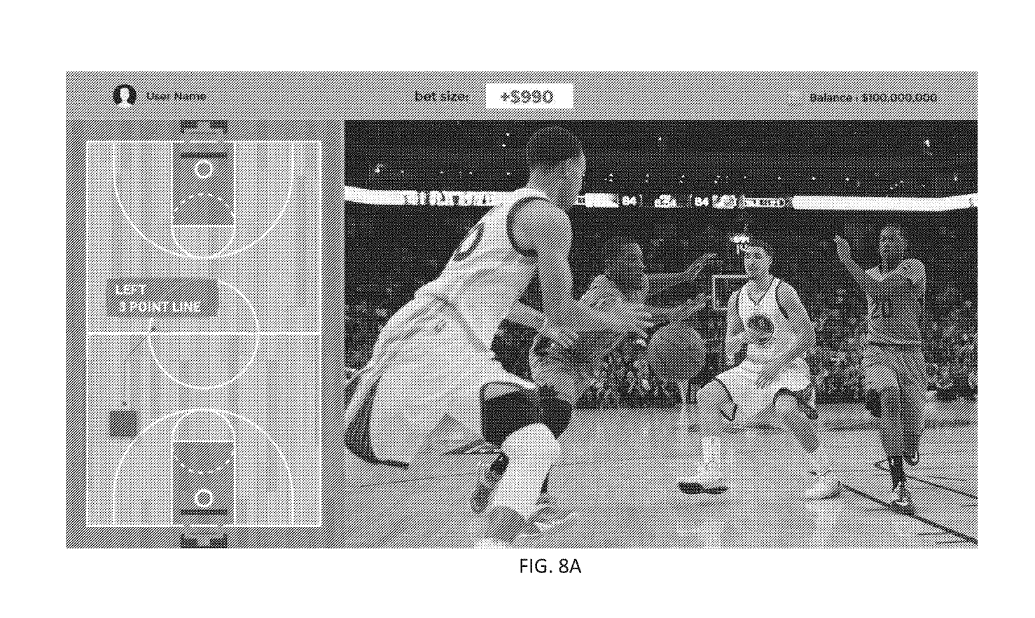

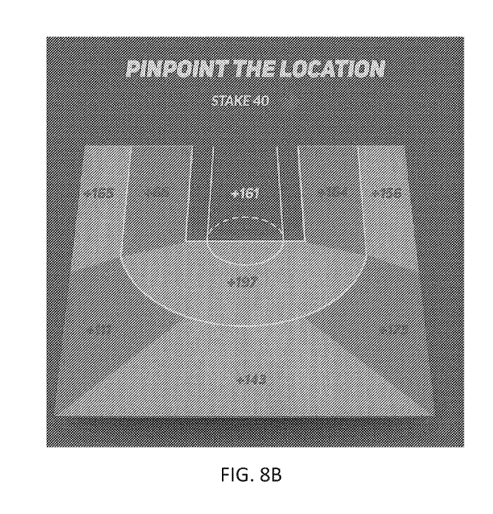

As can be seen in FIG. 8A, a GUI is shown that includes both a schematic view of a basketball field, and a live video view of the game in progress. In the example provided, an example of a future event may be where the next shot is launched from by a selected player, or various other examples.

FIG. 8B shows an example of a basketball field divided into wagering risk-pay areas or zones, according to some embodiments. In the example provided, standard basketball court zones are shown with their calculated wager payouts. Of course, other zones or areas, including creating areas or zones by the user, may be used.

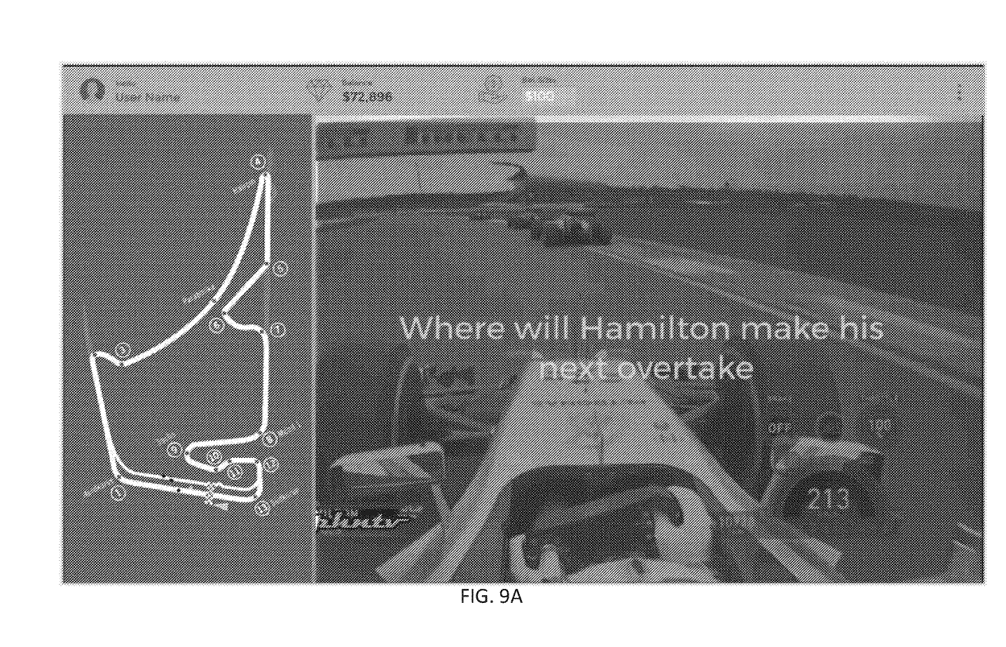

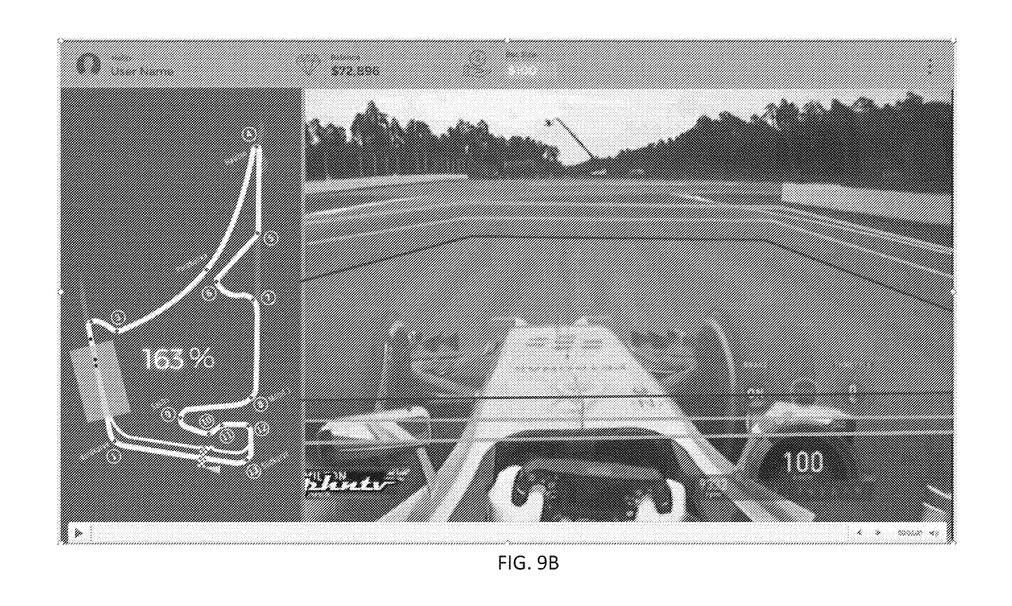

As can be seen in FIGS. 9A-9B, two GUIs are shown that include both a schematic view of a racing track, and a live video view of the event in progress, as well as location wagering interfaces, according to some embodiments. In the example provided, an example of a future event may be the location at which the racer in second position overtakes the racer in first position, or various other examples.

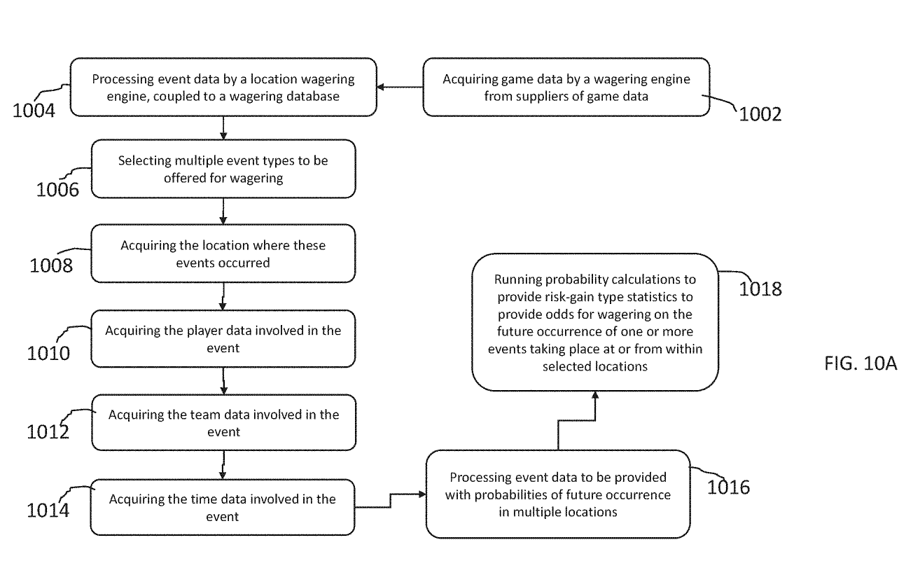

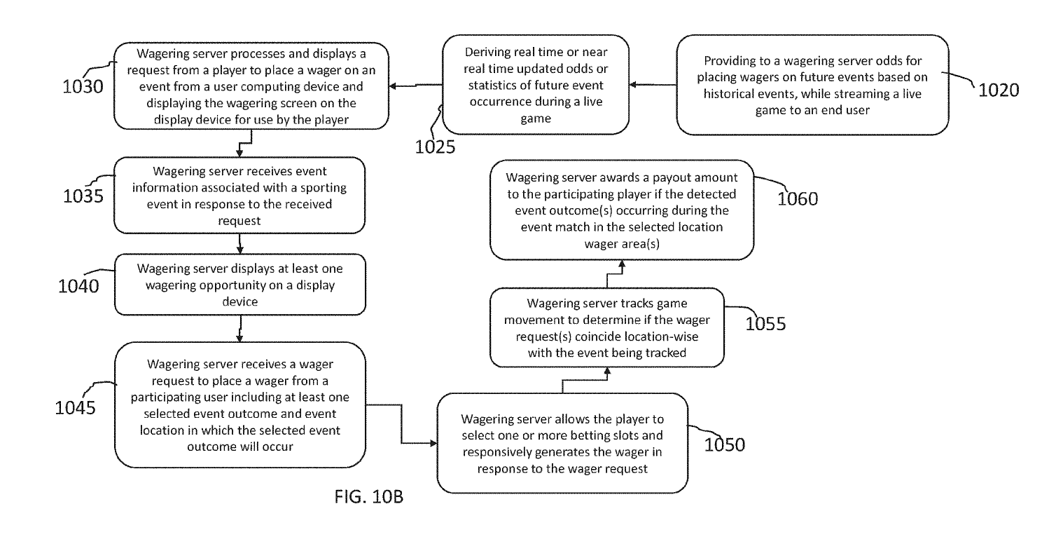

FIG. 10A is a flowchart showing an example of a process for generating location wagering statistics or probabilities on an event, according to some embodiments. Each method step may be performed independently of, or in combination with, other method steps. As can be seen, a wagering server receives and processes historical game data for a team and/or players on the team, for one or more event types, the data including location data (e.g., x and y positions of the team and/or player(s) during past events, or in a defined area or zone). As can be seen at step 1002, game data may be acquired by a wagering engine from suppliers of game data, for example, including multiple fields of data for multiple definable events at periodic intervals. Game data may be raw and/or dry game data, totally, substantially or largely unprocessed, or partially processed. At step 1004, this event data is processed by a location wagering engine, coupled to a wagering database, the processing steps including: at step 1006, selecting multiple event types to be offered, for example, for wagering; at step 1008, acquiring the location (point, area, zone etc.) where these events occurred; at step 1010, acquiring the player data involved in the event; at step 1012, acquiring the team data involved in the event; and at step 1014, acquiring the time data involved in the event. In some embodiments other event data or combinations of event data may be acquired, processed and used. At step 1016, the event data is processed, optionally using advanced algorithms or code, to be provided with probabilities of future occurrence in multiple locations. At step 1018 the probability calculations are used to provide risk-gain type statistics, for example, that may be used to provide odds or bets for wagering on the future occurrence of one or more events taking place at or from within selected locations.

FIG. 10B is a flowchart showing an example of generating a location wagering process on a live event, according to some embodiments. Each method step may be performed independently of, or in combination with, other method steps. As can be seen in FIG. 10B, at step 1020, the wagering server receives and process current data for a team and/or players on a team, for one or more current event types, the data including a location data (e.g., x and y positions of the team and/or player(s) during a current event and the identification of the event. In some embodiments, at step 1025, learning neural networks and/or other suitable data processing algorithms may be used to derive real time or near real time updated odds or statistics of future event occurrence during a live game. At step 1030, the server processes and displays a request from a player to place a location wager on an event from a user computing device, and provide a command to display the wagering screen on a display device being used by the player. At step 1035, the wagering server receives event information associated with a selected event in response to a received play or view request from a user. At step 1040, the wagering server sends a command to display at least one wagering opportunity on a display device. Further, the wagering server may update wagering opportunities throughout the game or event, optionally using artificial intelligence (AI) to update the opportunities in near real-time in accordance with the current game progress and the changing team and/or player statistics. At step 1045, the wagering server receives a wager request to place a wager from a participating user including at least one selected event outcome and location area in which the selected event outcome will occur. In some embodiments an event wager may be set on one or more pre-determined location spaces or areas. In further embodiments an event wager may be set on one or more user-determined location spaces or areas, for example, an area determined by a user pointing device or touch screen etc. At step 1050 the wagering server allows the player to select one or more betting slots and responsively generates wager data in response to the wager request(s). At step 1055 the wagering server receives near real time game data to determine if the wager request(s) coincide location-wise with the event being tracked. At step 1060 the wagering server awards a payout amount or other award to the participating player if the detected event outcome(s) occurring during the event match in the selected location wager area(s).

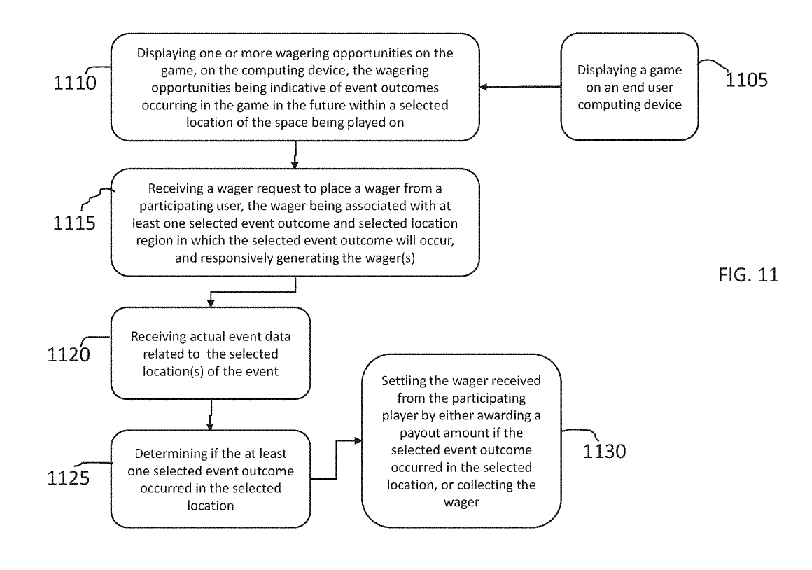

FIG. 11 is a flowchart showing a further example of a process for allowing a player to place a location wager on an event, according to some embodiments. Each method step may be performed independently of, or in combination with, other method steps. As can be seen, at step 1105, a wagering system displays a game on an end user computing device. At step 1110, the wagering system displays one or more wagering opportunities on the game, on the computing device, the wagering opportunities being indicative of event outcomes occurring in the game in the future within a selected location region of the space being played on. At step 1115, the wagering system receives a wager request to place a wager from a participating user, the wager being associated with at least one selected event outcome and selected location region in which the selected event outcome will occur, and responsively generates the wager(s). At step 1120, the wagering system receives actual event data related to the selected location region of the event. At step 1125, the wagering system determines if the at least one selected event outcome occurred in the selected location region(s) At step 1130, the wagering system settles the wager received from the participating player by either awarding a payout amount if the selected event outcome occurred in the selected location region(s), or collecting the wager.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A method for placing location-based wagers on an event, said method implemented by one or more processing devices operatively coupled to a non-transitory storage device, on which are stored modules of instruction code that when executed cause the one or more processing devices to perform
running in real time a location-based wager application on an end user device;
imposing a location-based wager interface over an event being run on the device, wherein the imposing includes presenting the area of the event, said area divided into wagering risk-pay zones, and presenting the wagering opportunities in each area;
receiving at least one a location-based wager by the device user;
processing the location-based wager to generate one or more wagering opportunities of event outcome based on the selected location based wager;
receiving user selection of one or more wagers opportunities
tracking the event to determine if a wager opportunity event outcome occurred in each zone of the event based on received information of the event regarding the selected zone and location of the live event; and
delivering the result of the wager in according to the wager location and the actual event occurrence.

2. The method of claim 1, further comprising collecting the wager, if the location-based wager did not occur.

3. The method of claim 1, further comprising paying out the wager gain, if the geographical wager occurred.

4. The method of claim 1, wherein the event is a live event.

5. The method of claim 1, wherein the event is an augmented reality event.

6. A location based wagering machine, comprising a wagering module running code to run a location-based wagering application on multiple end user devices.

7. The wagering machine of claim 6, wherein the wagering module is further adapted to run an interface on the one or more end user devices, the interface adapted to receive one or more location-based wagers based on pre-configured location areas, each location area being given a near real-time wager risk-pay calculation.

8. The wagering machine of claim 6, wherein the wagering module is further adapted to run an interface on the one or more end user devices, the interface adapted to receive one or more user-determined location area wagers, each location area being given a near real-time wager risk-pay calculation.

9. The wagering machine of claim 6, wherein the wagering module e is further adapted to run a location-based wagering application using a virtual reality interface on the one or more end user devices.

10. The wagering machine of claim 6, wherein the code is further adapted to run a location-based wagering application using an augmented reality interface on the one or more end user devices.

11. The wagering machine of claim 6, further comprising an end user device that includes a pointing component adapted to place a wager on one or more location-based spaces on a display of the end user device.

12. The wagering machine of claim 11 wherein the end user device comprises computing and/or communication devices selected from the group consisting of a PC, TV, tablet, smart phone, wearable device, communications box, game console and media player.

13. The wagering machine of claim 11, wherein the end user device is a touch
screen device adapted for displaying one or more location-based wagering areas, selectable using the touch screen of the device.

14. The wagering machine of claim 6, wherein the wagering server includes an augmented reality module.

15. A method for determining a location of an act to be performed in a game; the method comprising:
receiving a plurality of events associated with performing said act and a plurality of locations associated with performing said act; wherein each of said events is associated with an at least one location from said plurality of locations; analyzing said events; said analyzing is for associating a success rate of said act with each of said locations; and
presenting said analysis on a computing device; said presenting comprises a plurality of success rates associated with each of said locations; thereby increasing a success rate of an act occurring during a game.

16. The wagering machine of claim 1, wherein the calculating of wagering opportunities includes applying artificial Intelligence (AI) to substantially in real time record new statistics of team and/or player performance, and process the latest data and the historical data to generate updated wager opportunities calculations.

17. The method of claim 1, wherein the probabilities calculation include acquiring the player data involved in the event; acquiring the team data involved in the event; acquiring the time data involved in the event, for calculating probabilities of future occurrence in multiple locations, provide risk-gain type statistics of odds or bets for wagering on the future occurrence of one or more event outcome taking place at or from within selected locations.
